(19) United States
(12) Patent Application Publication
(10) Pub. No.: US 2008/0036384 A1
(43) Pub. Date: Feb. 14, 2008

(54) Lamp with high reflectance end coat

(76) Inventors: Ashfaqul I. Chowdhury, Broadview Heights, OH (US); Rajasingh S. Israel, Westlake, OH (US); Peter Brown, Twinsburg, OH (US); Tianji Zhao, Mayfield Heights, OH (US); Bart P. Terburg, Mayfield Village, OH (US)

Correspondence Address: FAY SHARPE LLP, 1100 SUPERIOR AVENUE, SEVENTH FLOOR, CLEVELAND, OH, 44114, US

(21) Appl. No.: 11/501,653

(22) Filed: Aug. 9, 2006

(51) Int. Cl. H01J 17/16

(52) U.S. Cl. 313/635

(57) ABSTRACT

An electric lamp (12) includes a generally cylindrical lamp vessel (16) which encloses an interior space (18). A source of illumination (20) is disposed within the interior space. A reflective layer (28) is disposed on a light transmissive first end (22) of the lamp vessel. The reflective layer reflects light emitted by the source of illumination into the interior space. The lamp is suited to use in a vehicle headlamp. The reflective layer enables the lamp to have a higher efficiency than a conventional lamp with a black end coat.

### BACKGROUND OF THE INVENTION

The exemplary embodiment relates to an electric lamp. It finds particular application in connection with a reflective end coat for an envelope of an automotive lamp.

Automotive lamps suited to use as vehicle headlights often include a light-absorbing end coat on the forward portion of the bulb. The lamp is accommodated in a reflector which reflects light towards a lens. The end coat is provided to prevent light emitted by a filament within the envelope from passing directly through the lens and causing glare. The end coat is generally a black paint which absorbs substantially all visible light, typically amounting to about 10% of the total light emitted from the lamp.

### BRIEF DESCRIPTION OF THE INVENTION

In one aspect of the invention disclosed herein, an electric lamp includes a generally cylindrical lamp vessel which encloses an interior space. A source of illumination is disposed within the interior space. A reflective layer is disposed on a light transmissive first end of the lamp vessel. The reflective layer reflects light emitted by the source of illumination into the interior space.

In another aspect, a method of forming a lamp includes providing a generally cylindrical lamp vessel which encloses an interior space and a source of illumination disposed within the interior space. A reflective layer is formed on a first end of the lamp vessel which reflects light emitted by the source of illumination.

In another aspect, an electric lamp includes a light transmissive lamp vessel which encloses an interior space. A source of illumination is disposed within the interior space. A reflective layer on one end of the lamp vessel reflects light emitted by the source of illumination. The reflective layer includes silver. A protective layer over the silver layer resists oxidation of the reflective layer.

### BRIEF DESCRIPTION OF THE DRAWINGS

FIG. 1 is a side view, in partial section, of a lamp assembly according to one aspect of the invention;

FIG. 2 is an enlarged cross sectional view of the lamp of FIG. 1 with a reflective end coat (not to scale) on one end;

FIG. 3 is a top view of an exemplary rack for coating lamps;

FIG. 4 is a side view of the rack of FIG. 3 with lamps mounted on the rack during coating; and

FIG. 5 illustrates steps in an exemplary lamp coating process.

### DETAILED DESCRIPTION OF THE INVENTION

Aspects of the exemplary embodiments disclosed herein relate to an electric lamp having a reflective end coat and a lamp assembly which includes the lamp as well as to a method of forming the exemplary lamp.

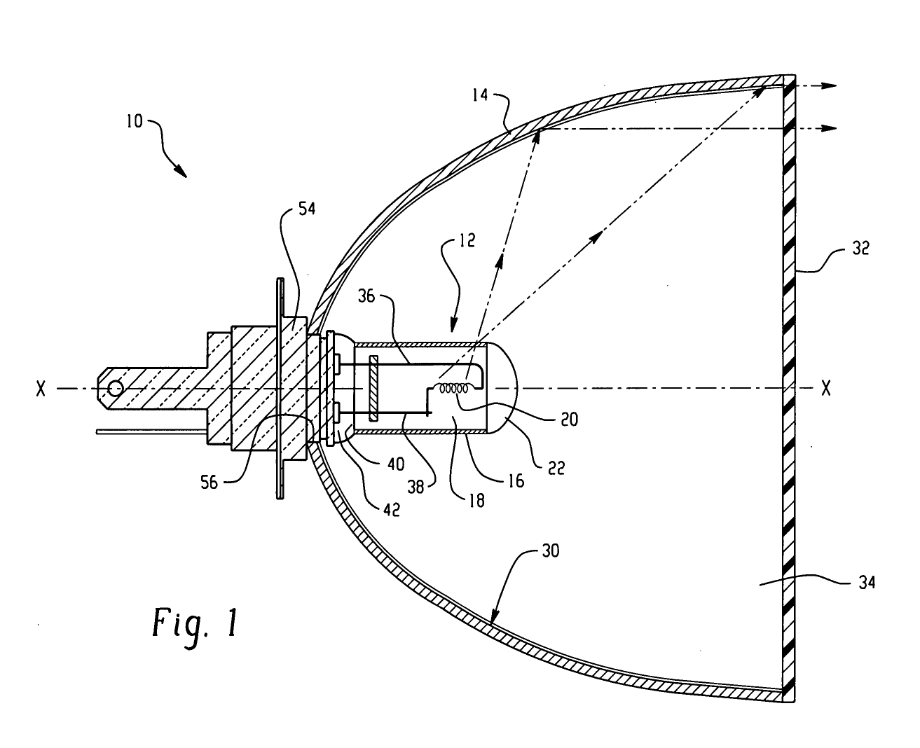

With reference to FIG. 1, a lamp assembly 10 suited to use as a vehicle headlamp includes an electric lamp 12, which is mounted in a reflector housing 14. The lamp includes a vessel or envelope 16. The vessel 16 may be formed from glass, quartz (high silica glass), or other light transmissive material which is stable at lamp operating temperatures. The vessel 16 is generally cylindrical and has its longitudinal axis aligned with an axis X of the reflector housing 14. By generally cylindrical it is meant that the lamp has a cross section which is consistent, within machine tolerances, between opposite ends of the lamp. The vessel is closed in vacuum tight manner to define an interior space 18 containing a halogen fill, typically comprising an alkyl bromide, such as CH₂Br₂, and an inert gas, such as argon or xenon. An incandescent light source 20, such as a filament, which may be formed from tungsten, is disposed within the vessel 16. The filament 20 has its longest dimension parallel to and substantially aligned with the longitudinal axis X.

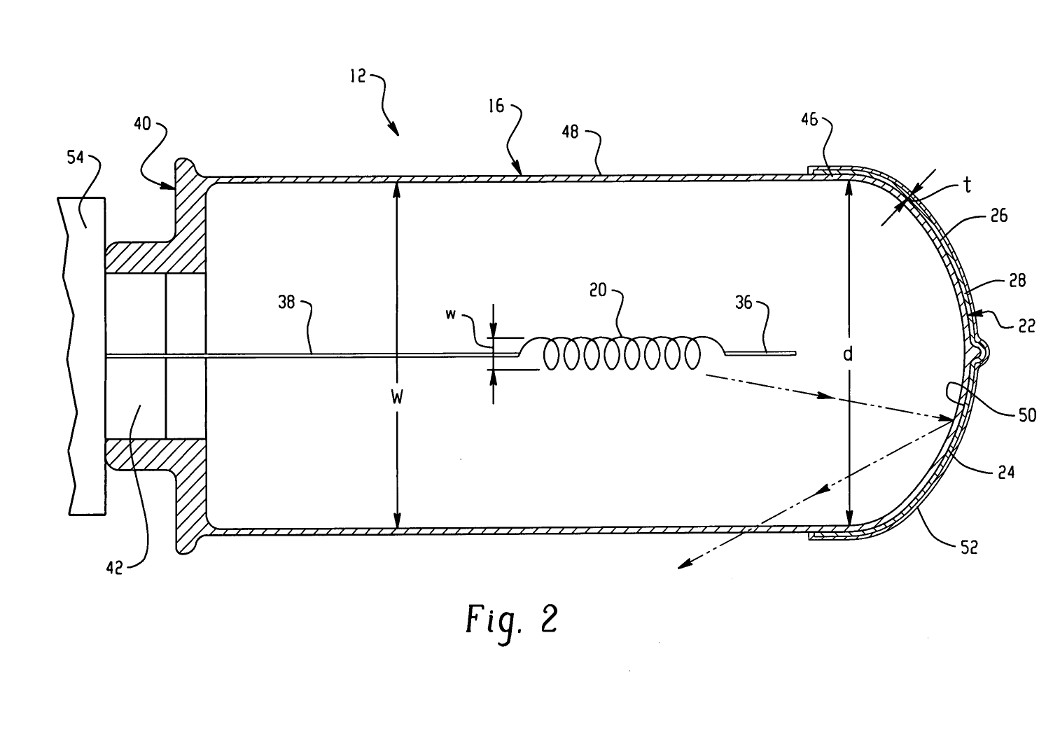

As shown in FIG. 2, which shows an enlarged view of the lamp 12, a light transmissive forward, first end 22 of the vessel 16 defines a convex tip 24 having a curved outer surface 26. A reflective layer or end coat 28 is formed on the outer surface 26 of the first end. As shown by the exemplary rays in FIG. 1, the lamp 12 is arranged in the reflector housing 14 such that substantially all light from the filament 20 transmitted through the vessel 16, either before or after reflection by the reflective layer 28, is reflected from a reflective surface 30 of the reflector housing 14 and exits the lamp assembly through a transparent window (or “lens”) 32, which covers an otherwise open end 34 of the reflector housing 14. In general, less than 10%, and in one embodiment, less than 1% of the visible light emitted by the lamp 12 which ultimately passes through the window 32 does so without being reflected by the reflector housing. This reduces glare when the lamp assembly is used for automotive applications as a vehicle headlamp.

The reflector housing 14 may be formed, for example, from plastic, glass, or aluminum. The housing may be itself reflective or may have a reflective coating formed thereon which defines the reflective surface. In the case of a plastic housing, the coating may be provided on an interior surface of the housing. In the case of glass, the coating may be provided on an interior or exterior surface. The reflective surface may be a metal, such as silver or aluminum, or may be defined by a dichroic coating comprising multiple layers of alternating higher and lower refractive index materials. The reflective surface may be parabolic, elliptical, or other suitable shape.

The illustrated filament 20 comprises a helical coil, generally aligned with the axis X of the reflector housing. The filament is supplied with electric current by leads 36, 38, which extend into the interior 18 from a second end 40 of the vessel 16, adjacent the reflector. The leads may be connected with outer connectors by molybdenum foils in a pinch area 42 of the vessel.

In another embodiment, the lamp 12 includes two filaments which are aligned generally parallel to each other, one for low beam and one for high beam. One or both of the filaments may be somewhat offset from the central axis X. Such a lamp configuration may include three leads (the forward ends of the filaments being connected to the same lead) whereby different voltages are applied to the two filaments.

As show in FIG. 2, the tip 24 of the vessel 16 and an annular contiguous portion 46 of a cylindrical sidewall 48 of the vessel 16 are covered with the reflective layer 28 (shown thicker than in practice for illustration purposes). The illustrated reflective layer 28 completely covers the tip 24 and extends along the portion 46 of the sidewall 48 for a sufficient distance to ensure that substantially no light from the filament passes through the widow without first being reflected by the reflective surface of the reflector housing. For example, the layer 28 may extend about 2-4 mm along the cylindrical sidewall 48. Specifically, that portion 46 of the sidewall covered by the coating 28 has a maximum diameter d (perpendicular to the axis X) which is no less than a maximum width W of the lamp vessel. Of course, in the illustrated embodiment, where the sidewall 48 is perfectly cylindrical (within normal tolerances) d=W.

With continued reference to FIG. 2, the reflective layer 28 may be formed as a coating on an exterior of the lamp vessel and defines a reflective interior surface 50, in contact with the exterior surface 26 of the vessel, which reflects light received from the filament. Due to the curvature of the tip 24, the reflective interior surface 50 acts as a substantially parabolic reflector which reflects light incident thereon back through the interior 18 of the vessel, and through the sidewall 48 towards the reflector housing. The reflective coating 28 is thus provided only on one end of the lamp, leaving the second end 40 entirely free of the reflective layer. As a result, substantially all light incident on the reflective interior surface 50 is directed through the cylindrical side wall 48 to toward the reflector housing 14 rather than to the filament 20, thereby improving the efficiency of the lamp. In general, at least about 70%, and in one embodiment, at least 80%, e.g., at least 90% of the light reflected by the reflective interior surface 50 is incident on the reflective surface 30 of the reflector without first striking the filament 20. The illustrated filament 20 has a width w which is relatively narrow, in comparison with an interior width W of the vessel 16 to present a narrow profile to the light reflected from the reflective layer 28. For example, the width w may be less than about 1.5 mm, e.g., about 1 mm and the width W may be about 10 mm. The ratio of a cross sectional area of the vessel 16 to the cross sectional area of the filament 20 is at least about 25:1, e.g., at least 50:1, and in the illustrated embodiment, is about 100:1.

The reflective layer 28 is formed from a reflective material which reflects more light than it absorbs and transmits. For example, at least about 70% of all incident visible light (typically in the range of about 400-700 nm) is reflected and less than about 30% is absorbed or transmitted, and in one embodiment, at least 80% or at least 85% of the visible light incident at the reflective layer/glass interface is reflected, and the percentage may be up to about 95%, or higher. Exemplary materials which may be used for the reflective layer 28 include Ag, Al, Au, Cr, Cu, Ni, Pd, Pt, Rh and combinations thereof, such as nickel chrome, stainless steel, and the like. In one embodiment, the reflective layer is formed from silver (Ag) or an alloy thereof. In one embodiment, the reflective layer is formed primarily from silver (e.g., at least 80% silver, or at least 95% silver). The silver layer 28 has a reflectance generally of about 85-97%. The remaining light (e.g., about 3-5%), is absorbed by the silver layer 28, rather than being transmitted.

The reflective layer 28 has a sufficient thickness t that it is substantially non transmissive to light in the visible range of the spectrum. For example, less than about 1% of incident light is transmitted through the layer 28, and in one embodiment, less than about 0.1% is transmitted. In the case of silver, for example, the layer 28 may be at least about 0.05 micrometers (μm) in thickness and can be up to about 10 μm or higher. In general, a thickness of at least 0.2 μm, and up to about 2 μm, e.g., less than about 0.4 μm, is suitable to ensure that pinpricks of light do not escape through discontinuities in the coating 28. For example, the layer 28 may have an average thickness of about 0.3 μm.

Where the reflector housing 14 is not hermetically sealed, oxygen inside the reflector housing may contribute to oxidation of the reflective coating 28, particularly when formed of silver. In one embodiment, a protective layer 52 covers the reflective layer 28 and substantially seals it against oxidation. The protective layer 52 is spaced from the vessel 16 by the reflective coating 28 and, in general, does not extend substantially beyond the reflective layer 28 along the sidewall 48. The protective layer 52 may be formed from a stable dielectric film, such as oxides and nitrides that are substantially light transmissive such that the reflective silver layer 28 is visible therethrough when viewed from an exterior of the lamp assembly. This enables a user to identify the lamp 12 as having the reflective coating and also provides a pleasing visual appearance to the lamp. Suitable dielectric films for forming the protective layer 52 include oxides and/or nitrides of silicon and/or tantalum, e.g., silicon dioxide, silicon nitride, or hydrogenated silicon oxycarbon (H:SiOC) complexes. In one embodiment, the protective layer 52 may be at least about 0.05 μm in thickness and in one embodiment, at least about 0.1 μm and can be up to about 10 μm, or more, e.g. less than about 0.2 μm.

In another embodiment, the protective layer 52 comprises a substantially non-transmissive (e.g., light absorbing) material. For example, a black light-absorbing layer may be a paint comprising a pigment, for example ethyl-silicate paint, with silicon or a mixture of transition metal oxides therein, for example of Fe, Mn, or Ti, as the black pigment.

In operation, the lamp vessel 16 is fitted to a lamp cap 54 and seated in an opening 56 in the reflector housing and connected to a source of power (not shown). An electric current is applied across the filament 20 to generate light in the visible region of the spectrum. The visible light is transmitted by the light transmissive portion of the vessel, including light which is first reflected by the reflective layer 28. In other embodiments, the light source 20 may be provided by a gas discharge generated in an arc gap between spaced electrodes.

The illustrated lamp 12 can meet standards for automotive lamps which set limits on the amount of light which is emitted in a forward direction (i.e., towards the window 32). Currently, the standard in the U.S. is provided by 49 C.F.R. 564-Replacement Light Source Information (Part 564) and in Europe by ECE Regulation R37. The lamp 12 may be of the H7 type (nominally 53.5 W, 1350 lumens).

The exemplary lamp 12 may have a light output in lumens which is at least about 10% higher than an equivalent lamp formed with a light-absorbing (black) end coat, and may be up to about 20%. In practice, because of the higher efficiency (lumens/watt), the lamp may be run at lower power than a conventional black end-coated lamp.

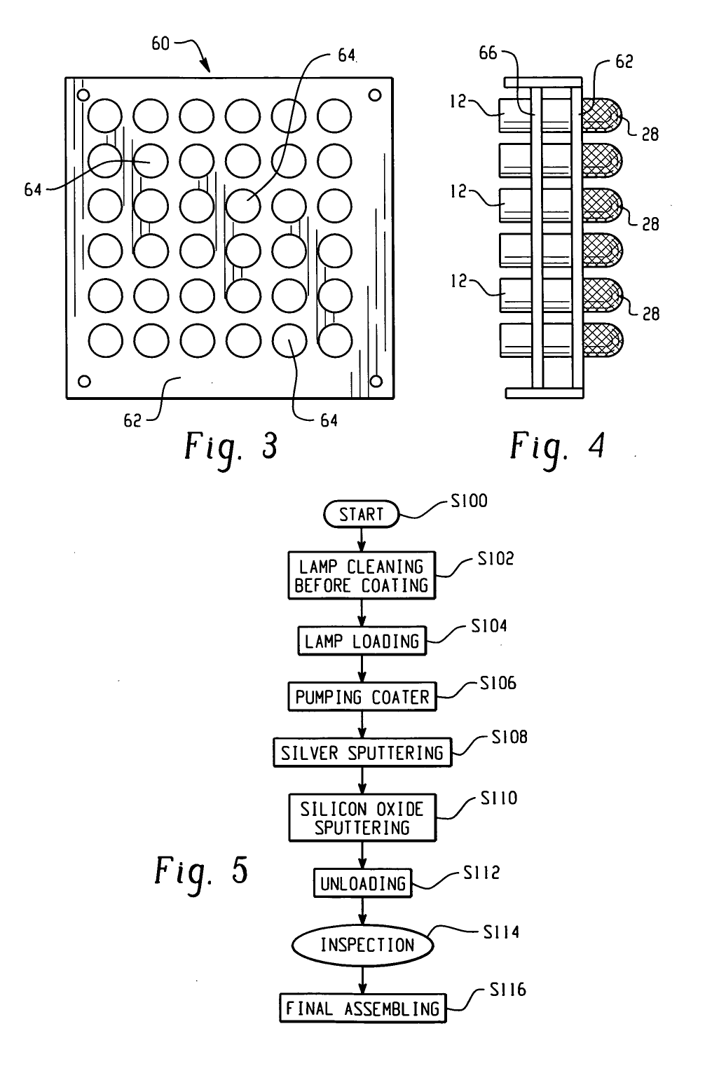

FIGS. 3 and 4 illustrate a rack 60 which may be used during coating of the exemplary lamp 12. The rack 60 includes a metal plate 62 with spaced circular openings 64 therein which are each sized to receive an end 22 of the lamp therethrough. The rack includes a spring-loaded clamp 66 which holds the lamps in position to control the coating area.

Suitable techniques for forming one or both of the layers 28, 52 include vacuum deposition, dip coating, spraying, and the like. The reflective layer 28, for example, is deposited by vacuum deposition methods, such as sputtering, Ion-Assisted-Deposition (IAD), physical vapor deposition (PVD) or chemical vapor deposition (CVD), or by other known processes, such as thermal evaporation or dip coating. For example, in magnetron sputtering, high energy inert gas plasma is used to bombard a target, such as silver. The sputtered atoms condense on the cold glass or quartz vessel 16. DC (direct current), pulsed DC (40-400 KHz), or RF (radio frequency, 13.65 MHz) processes may be used. The protective layer may be formed, for example, by magnetron sputtering a silicon-containing target in an oxygen atmosphere or by plasma enhanced chemical vapor deposition (PECVD) of a hydrogenated silicon oxycarbide polymer from a hexamethyldisiloxane (HMDSO) fluid, such as Wacker Silicone Fluid AK 0.65 (99%+HMDSO, <0.5 ppm CI) supplied by Wacker Chemical Corporation, Adrian, Mich., or alternatively hexamethyldisiloxane 99%+(<0.5 ppm CI) supplied by Alfa Aesar, Ward Hill, Mass.

An exemplary method of preparing the coated lamps is illustrated in FIG. 5. The method begins at step S100. At step S102, the lamps are cleaned to remove surface dirt. This ensures that the silver coating has good adhesion to the lamps. Several lamps are loaded into the rack 60 (S104) and clamped in position. The rack and lamps are positioned in an evacuated sputtering chamber with the tips facing a silver target. The chamber is evacuated (S106) and a silver target is sputtered to provide a layer of the desired thickness on the exposed tips of the lamps (S108). The rack may then be rotated between a suitable silver target position and a silicon target position. A small amount of oxygen is introduced to the chamber and a silicon target is sputtered to produce a silicon oxide layer 52 (S110). Alternatively, in the case of a hydrogenated silicon oxycarbide coating, hexamethyldisiloxane is introduced to the chamber at step S110. After venting the chamber from vacuum to atmosphere, the rack and coated lamps are unloaded from the chamber (S112) and inspected for defects (S114) prior to final assembly in the lamp cap (S116). It will be appreciated that the method is not limited to the steps illustrated and that fewer, more, or different steps may be employed or that the order of the steps may differ.

The invention has been described with reference to the preferred embodiments. Obviously, modifications and alterations will occur to others upon reading and understanding the preceding detailed description. It is intended that the invention be construed as including all such modifications and alterations.

What is claimed is:

1. An electric lamp comprising:
a generally cylindrical lamp vessel which encloses an interior space;
a source of illumination disposed within the interior space;
a reflective layer disposed on a light transmissive first end of the lamp vessel, the reflective layer reflecting light emitted by the source of illumination into the interior space.

2. The electric lamp of claim 1, wherein the lamp vessel defines a second end which is free of the reflective layer.

3. The electric lamp of claim 2, further comprising a lamp cap at the second end of the lamp vessel.

4. The electric lamp of claim 1, wherein the reflective layer defines a reflective surface at an interface between the lamp vessel and the reflective coating.

5. The electric lamp of claim 1, wherein the first end of the lamp vessel is curved and the reflective layer is in direct contact with the curved end of the lamp vessel.

6. The electric lamp of claim 5, wherein the lamp vessel includes a cylindrical sidewall which extends from the curved first end and wherein the reflective layer extends partway along the cylindrical wall of the lamp vessel.

7. The electric lamp of claim 1, wherein the source of illumination comprises a filament.

8. The electric lamp of claim 1, wherein the reflective layer comprises silver.

9. The electric lamp of claim 1, wherein the reflective layer has a thickness of at least 0.1 nm.

10. The electric lamp of claim 1, further comprising a protective layer over the reflective layer.

11. The electric lamp of claim 10, wherein the protective layer comprises an oxide of silicon.

12. The electric lamp of claim 10, wherein the protective layer comprises a hydrogenated silicon oxycarbide.

13. The electric lamp of claim 1, wherein the reflective layer is reflecting as viewed from outside the lamp vessel.

14. A lamp assembly comprising the electric lamp of claim 1 and a reflector housing, the lamp being mounted within the reflector housing such that substantially all light emitted by the lamp which exits the reflector housing is reflected by the reflector housing.

15. The lamp assembly of claim 14, wherein less than 10% of light emitted by the lamp is emitted without reflection by the reflector housing.

16. The lamp assembly of claim 15, wherein less than 1% of light emitted by the lamp is emitted without reflection by the reflector housing.

17. The lamp assembly of claim 14, wherein the lamp vessel is axially aligned with a longitudinal axis of the reflector housing.

18. The lamp assembly of claim 14, wherein the reflective layer defines a reflective interior surface which has a curvature such that the reflective surface reflects substantially all incident light from the filament in a direction away from the filament.

19. The lamp assembly of claim 14, wherein the lamp assembly is a vehicle headlamp.

20. A method of forming a lamp comprising:
providing a generally cylindrical lamp vessel which encloses an interior space and a source of illumination disposed within the interior space;
forming a reflective layer on a first end of the lamp vessel which reflects light emitted by the source of illumination.

21. The method of claim 20, further comprising:
forming a protective layer on the reflective coating which protects the reflective layer from oxidation.

22. An electric lamp comprising:
a light transmissive lamp vessel which encloses an interior space;
a source of illumination disposed within the interior space;
a reflective layer on one end of the lamp vessel which reflects light emitted by the source of illumination, the reflective layer comprising silver; and
a protective layer over the silver layer which resists oxidation of the silver layer.
